(19) United States
(12) Patent Application Publication
(10) Pub. No.: US 2006/0179636 A1
(43) Pub. Date: Aug. 17, 2006

(54) Wire twisting method and apparatus

(75) Inventor: Gilberto Valenzuela, Corona, CA (US)

Correspondence Address: Robert R. Meads, 210 Paseo de Suenos, Redondo Beach, CA, 90277, US

(73) Assignee: Six-Pac Recycling, Inc.

(21) Appl. No.: 11/058,792

(22) Filed: Feb. 16, 2005

(51) Int. Cl. B23P 11/00

(52) U.S. Cl. 29/514; 29/505

(57) ABSTRACT

A method and apparatus for twisting wire using an axially elongated hand-holdable tool having an outer axially extending slot and an inner axially extending hole in an end thereof for receiving and supporting an axially extending length of wire and an adjacent end of the wire respectively during a turning of the tool on a longitudinal axis thereof.

### FIELD OF INVENTION

The present invention relates to methods and apparatus for use in the bailing of compressed recyclable articles, and, more particularly, to methods and apparatus for twisting wire used to contain such compressed articles in compact bails.

### BACKGROUND

In the past, various tools and apparatus have been utilized to twist together ends of lengths of wire in the bailing of objects and materials of various sizes and shapes. Such tools and apparatus have varied from relatively simple wrenches and pliers of different sizes and shapes to more elaborate combinations including screws, clamps, levers and gears. Prior simple tools have been inefficient in operation requiring the exertion of considerable physical energy. The more elaborate tools have been complex and expensive. The object of the present invention is to provide a simple inexpensive wire twisting tool that easily and efficiently twists the ends of wires into interconnecting loops ideally suited to the bailing of compressed recyclable articles.

### SUMMARY OF INVENTION

Basically, the present invention comprises a method and apparatus for twisting wire using an axially elongated hand-holdable one-piece tool having an outer axially extending slot and an inner axially extending hole in a forward end thereof. Basically, the method comprises the steps of (1) bending one end of a longitudinally extending length of wire to form a generally U-shaped end portion having a long leg comprising the length of wire and a relatively short bent leg portion, (2) axially securing the U-shaped end portion, (3) inserting an end of the bend portion of wire into the hole in the forward end of the tool and laying the long leg of wire in the open outer slot in the tool and (4) turning the tool on a longitudinal axis thereof while the tool moves axially rearward relative to the long leg of wire to form a loop in a forward end of the length of wire and to twist the bent leg portion over and rearward along and around the long leg of wire adjacent the loop.

### BRIEF DESCRIPTION OF THE DRAWINGS

FIG. 1 is a perspective view of the elongated tool used in the method of the present invention and comprising an axially extending outer slot and the inner axially extending hole in a forward end of the tool.

FIG. 2 is a front-end view of the tool shown in FIG. 1.

FIG. 3 is a side view of a ratchet wrench useful in the method of the present invention and including a radially extending slot in the ratchet head of the wrench.

FIGS. 4 through 11 illustrate steps in the method of the present invention useful in forming a bail of recyclable items as shown in FIG. 12; FIG. 4 illustrating the method steps of bending the end of a length of wire to a substantially U-shape and axially securing the bent wire as by passage of the bent wire into a loop formed in the end of an second length of wire or the opposite end of the illustrated length of wire,

FIG. 5 illustrating the method step of positioning the bend end of the wire for support in the tool of FIG. 1,

FIG. 6 illustrating the method step of insertion of the bent end of the wire in the axial hole in the tool and placement of the length of wire in the outer slot of the tool,

FIG. 7 illustrating the positioning of the ratchet wrench of FIG. 3 adjacent the tool of FIG. 1 with the length of wire passing through the radial slot in the head portion of the ratchet wrench and the wire located in and along the tool,

FIG. 8 illustrating the ratchet wrench and tool of FIG. 7 after the wrench has fully received the bent end of wire and is about to receive the tool,

FIG. 9 illustrating the ratchet wrench on the tool ready to turn the tool by vertical swinging reciprocation of the wrench,

FIG. 10 illustrating the wrench on the tool after the reciprocation of the wrench and several turnings of the tool about its longitudinal axis and after axial rearward movement of the tool and wrench on the length of wire to form a loop in the bent end of wire and a twisting of the wire contained in the axial hole of the tool along and around the wire contained in the outer axial slot of the tool,

FIG. 11 illustrating the connection of the loop formed by the tool in the bent end of wire with the loop in the end of the wire shown in FIG. 4 and

FIG. 12 illustrating a bail of recyclable material secured by wires secured at their respective ends by locking loops formed by wire ends twisted according to the method of the present invention using the tool and ratchet wrench comprising the apparatus of the present invention.

### DETAILED DESCRIPTION OF INVENTION

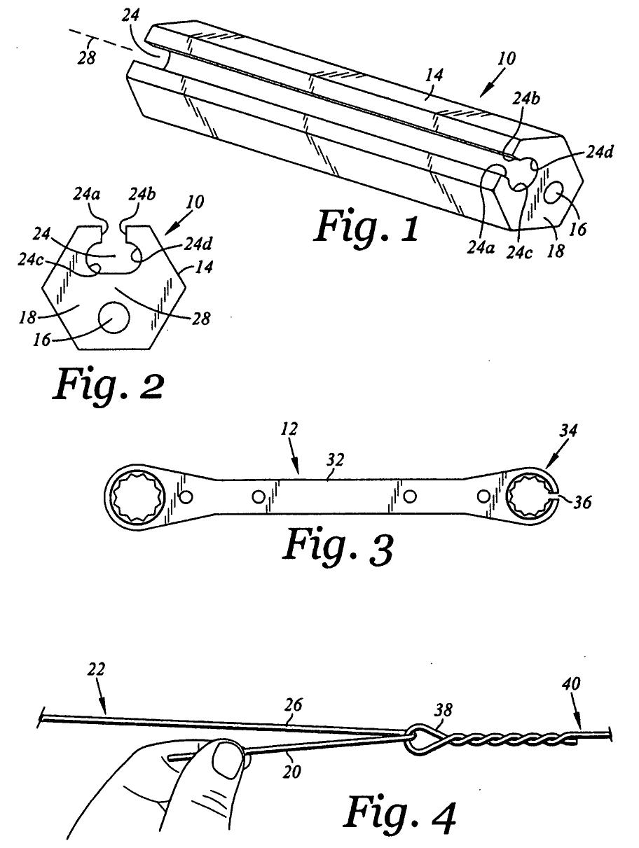

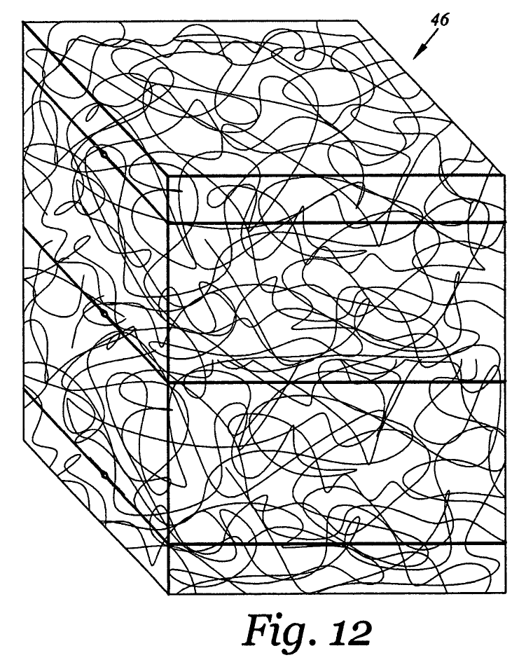

As depicted generally in the drawings, the present invention comprises a method and apparatus for twisting wire including the steps illustrated in FIGS. 4-11 using the tool and wrench of FIGS. 1-3. Preferably, the method of use of the apparatus results in the formation of bails of articles such as the bail of recyclable items depicted in FIG. 12.

As stated, the apparatus of the present invention comprises a tool 10 as represented in FIGS. 1 and 2 and a wrench 12 as shown in FIG. 3.

Basically, the tool 10 comprises an axially extending and elongated hand-holdable tool body 14 having an axially extending hole 16 in a forward end 18 thereof for receiving an end portion 20 of a length of wire 22. The tool body 14 may be formed of any suitable light-weight metallic material and may be of a hexagonal cross-section for easy gripping by the wrench included in the apparatus of the present invention. Also, the hole 16 preferably extends the length of the tool body 14 to allow the end portion 20 to initially extend beyond a rear end 30 of the tool body 14.

In addition, the tool body 14 includes an axially extending open outer slot 24 for receiving a portion 26 of the length of wire 22 adjacent the end portion 20 extending into the hole 16 in the forward end 18 of the tool. Preferably, the slot 24 has inwardly extending upper edge portions 24a and 24b. The edge portions 24a and 24b vertically limit movement of the wire portion 26 within the slot 24 while opposing sides 24c and 24d of the slot below the edge portions limit lateral movement of the wire portion 26 within the slot during a turning the tool 10 on a longitudinal axis 28 thereof by hand reciprocation of the wrench included in the apparatus of the present invention.

In these regards, the wrench preferably comprises the ratchet wrench 32 of conventional design. An annular ratchet head portion 34 of the wrench 32 is dimensioned to axially receive the tool body 14 while a radially extending open ended slot 36 in the head portion 34 is dimensioned to allow passage of the wire portion 26 into the annular head portion during the mounting of the wrench on the tool body.

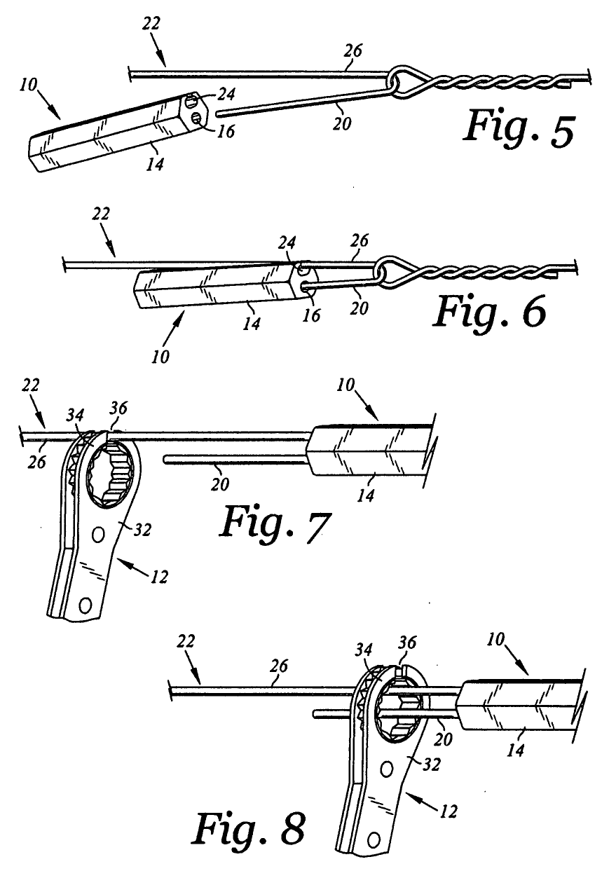

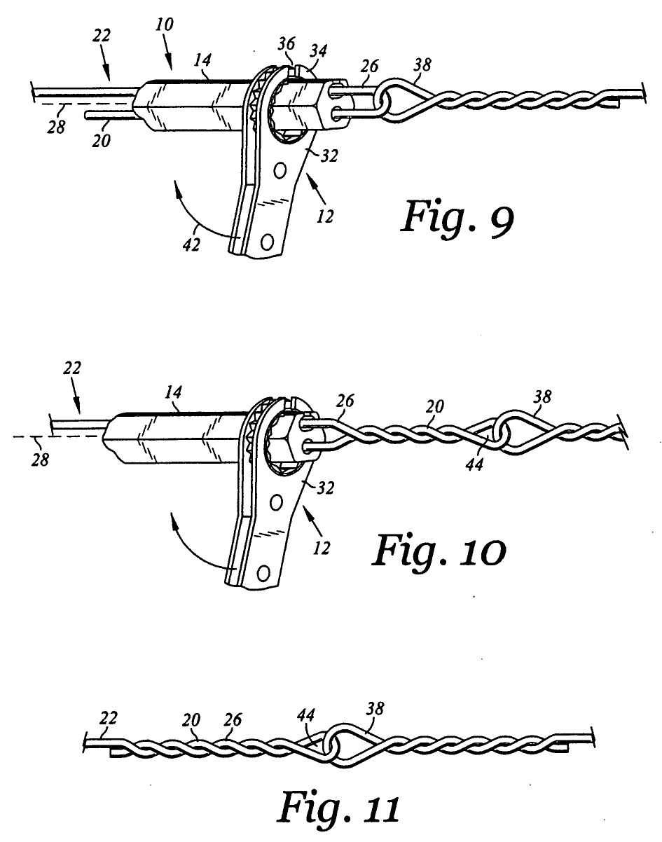

As stated, the method of the present invention using the apparatus of the present invention is depicted by the steps illustrated in FIGS. 4-11. FIG. 4 illustrates the method step of bending the end portion 20 of a length of wire 22 to a substantially U-shape having a relatively long leg comprising the wire portion 26 and a relative short leg comprising the wire portion 20. FIG. 4 also illustrates the method step of axially securing the bent wire as by passage of the wire portion 20 into and through a loop 38 formed in an end of an second length of wire 40 or an opposite end of the illustrated and previously described length of wire 22. FIG. 5 illustrates the method step of positioning the bent end portion 20 for axial insertion into the hole 16 for support in the tool 10 of FIG. 1. FIG. 6 illustrates the method step of inserting the bent wire end portion 20 into the axial hole 16 in the tool and placement of the wire portion 26 in the outer slot 24 of the tool 10. FIG. 7 illustrates the positioning of the ratchet wrench 32 of FIG. 3 adjacent the tool 10 of FIG. 1 with the wire portion 26 passing through the radial slot 36 in the head portion 34 of the ratchet wrench 32 and the wire portions 26 and 20 respectively located in and extending through the tool 10. FIG. 8 illustrates the ratchet wrench 32 and tool 10 of FIG. 7 after the wrench has fully received the wire end portions 20 and 26 and is about to receive the tool 10. FIG. 9 illustrates the ratchet wrench 32 on the tool body 14 ready to turn the tool 10 on its longitudinal axis 28 in response to vertical swinging reciprocation of the wrench as indicated by the arrow 42 in FIGS. 9 and 10. FIG. 10 illustrates the wrench 32 on the tool body 14 after several turnings of the tool body about the longitudinal axis 28 and axial rearward movement of the tool 10 and wrench 32 on the wire portion 26 to form a loop 44 in the wire 22 at a junction of the bent wire end portion 20 and the relatively long wire portion 26 and a twisting of the wire portion 20 contained in the axial hole 16 of the tool body 14 along and around the wire portion 26 contained in the outer axial slot 24 of the tool 10. FIG. 11 illustrates the connection of the loop 44 formed by the tool with the loop 38 in the end of the wire shown in FIG. 4. Finally, FIG. 12 illustrates a bail 46 of recyclable material such as collapsed cardboard boxes secured by wires secured at their respective ends by locking loops (such as 44 and 38 in FIG. 11) formed by wire ends twisted according to the method of the present invention using the tool and ratchet wrench comprising the apparatus of the present invention.

While a particular embodiments of the method and apparatus of the present invention has been illustrated and described in detail above, it is appreciated the changes and modifications may be made in the illustrated embodiments without departing from the spirit of the invention. For example, the one-piece tool 10 is constructed such that if a forward end of the tool body 14 or forward ends of the axial hole or outer slot 24 should become worn with use of the tool 10, the tool 10 may be reversed so that the wire end portions 20 and 26 may be introduced into the original rear ends of the hole 16 and slot 24 without altering the steps comprising the method of the present invention. Accordingly, the scope of present invention is to be limited only by the terms of the following claims.

1. A method of twisting wire using an axially elongated tool having an outer axially extending open slot and an inner axially extending hole in an end of the tool, comprising the steps of:
bending one end of a longitudinally extending length of wire to form a U-shaped end portion having a long leg comprising the length of wire and a relatively short bent leg portion;
axially securing the U-shaped end portion;
inserting an end of the short bent leg into the axially extending hole in the end of the tool and placing the long leg of wire in the outer axially extending slot in the tool; and
turning the tool on a longitudinal axis of the tool while the tool moves axially rearward relative to the long leg of wire to form a loop in the U-shaped portion of the wire forward of the tool and to twist the bent leg portion over and rearward along and around the long leg of wire rearward of the loop.

2. The method of claim 1 wherein the step of turning and axially moving the tool comprises positioning a ratchet wrench on the tool and reciprocating the wrench as the tool is moved rearward relative to the length of wire.

3. A wire turning tool for forming a closed loop in an end of a length of wire and a twisted portion of the length of wire adjacent to closed loop, the tool comprising:
an axially extending and elongated hand-holdable tool body having an axially extending inner hole in an end thereof for receiving an end of a length of wire, and
an axially extending outer slot for receiving a portion of the length of wire adjacent the end received by the hole in the forward end of the tool for laterally securing and axially guiding the portion of the length of wire during a turning the tool on a longitudinal axis thereof.

4. The tool of claim 3 wherein the inner hole extends axially through the tool body.

5. The tool of claim 4 wherein the tool body is of a hexagonal cross-section.

6. Apparatus for twisting wire comprising:
an axially extending and elongated hand-holdable tool body having an axially extending inner hole in an end thereof for receiving an end of a length of wire, and an axially extending outer slot for receiving a portion of the length of wire adjacent the end received by the hole in the forward end of the tool for laterally securing and axially guiding the portion of the length of wire during a turning the tool on a longitudinal axis thereof and a wrench for turning the tool body on a longitudinal axis thereof.

7. The apparatus of claim 6 wherein the wrench is a ratchet wrench having a radial slot in a head portion thereof.
